(19) United States
(12) Patent Application Publication
(10) Pub. No.: US 2003/0049437 A1
(43) Pub. Date: Mar. 13, 2003

(54) Flexible carrier tape having high clarity and conductivity

(76) Inventors: Laura C. Devaney, Austin, TX (US); Carol A. Marek, Cedar Park, TX (US); Jack L. Price, Austin, TX (US); Ruben E. Velasquez Urey, Austin, TX (US)

Correspondence Address: Office of Intellectual Property Counsel, 3M Innovative Properties Company, P.O. Box 33427, St. Paul, MN, 55133-3427, US

(21) Appl. No.: 09/923,008

(22) Filed: Aug. 3, 2001

(51) Int. Cl. B32B 15/04; B65D 85/00; B65D 85/30; B65D 85/48; B32B 7/12

(52) U.S. Cl. 428/343; 206/714; 428/354

(57) ABSTRACT

A cover tape for an electronic component carrier including a polyester substrate, a layer of an electrically conductive coating comprising a dispersion of a conductive polymer selected from the group consisting of polythiophenes and polyanilines, said polymer having a conjugated polymer backbone and polymeric polyanion compounds, and a binder coated on at least a portion of at least one major surface of the substrate, and a layer containing a polymeric pressure-sensitive adhesive composition, where the tape having a degree of clarity of from about 80% to about 99%, and a surface resistance of from about 1×10⁴ to about 1×10¹² Ohm.

### BACKGROUND OF THE INVENTION

1. Field of the Invention

The disclosures herein relate generally to cover tapes used to seal electronic component carrier tapes having a number of indented segments for safe transportation of delicate electronic components.

### BACKGROUND

As electronic parts have become more miniature, storage, transportation and handling of such components has become more difficult, and specialized methods have evolved. One such method is use of a carrier tape. A carrier tape can be formed of a variety of materials, but are typically a plastic material formed in a strip which has multiple longitudinal recesses or indentions meant to hold individual components to prevent them from touching each other or being otherwise exposed to trauma. Such indented segments must have an upper opening by which the component is placed into the recess, and then the opening must be sealed, generally by means of a cover tape.

One material suggested for the cover tape used in punched carrier tapes is a multi-layer laminated polymeric foam structure, as in U.S. Pat. No. 4,657,137. This tape requires the use of at least two separate layers and is produced by providing a flexible thin plastic or foam layer to which a strong and stable base layer is laminated.

The carrier tape disclosed in U.S. Pat. No. 4,964,405 has a cover tape pasted with an adhesive which seals only the recesses and leaves the guide perforations open.

The cover tapes normally used for carrier tapes have e.g., nylon based substrates coated at least partially with an adhesive such as ethylene/vinyl acetate. See e.g., U.S. Pat. No. 4,963,405.

One difficulty with carrier tapes and cover tapes has been providing an appropriate cover tape which seals the individual components which does not somehow provide contamination of adhesive or release agent as well. The carrier tape or the cover tape must also provide some protection against the development of static electricity, which damages such fine electronic components; in fact, the winding and unwinding of the cover tape can exacerbate such problems by generating static charges. Cover tapes are often made with a static dissipative strip in the middle of the adhesive, which is derived from a vapor coated metal. This strip covers the adhesive and protects the component from the electrical discharge by bleeding off developing tribocharges. However, such strips are opaque, which means that the component cannot be viewed in its indentation, and they are quite expensive. Dispersed metals and carbon likewise introduce undesired opacity and contamination. The industry is requiring more inspection of the components while still inside the carrier tape, so transparency is becoming a most important requirement.

In U.S. Pat. No. 6,171,672 B1, static dissipative coatings are disclosed which contain carbon, a cation, an anion, and an unspecified organopolymeric conductor of the like. Ionic salts are not permanent coatings, and may leach out, adding to the contamination issue. Further, they are humidity dependent and can be corrosive. Further, such carbon and metals are opaque.

Intrinsically electrically conductive polymers have been developed in the recent decade which are useful for antistatic layers and coatings. U.S. Pat. No. 5,354,613 discloses a sheet material coated with an outermost coherent antistatic layer which contains a polythiophene with conjugated polymer backbone in the presence of a polyanionic compound and a dispersion of a hydrophobic polymer with a glass transition temperature of at least 40° C. Many of these conductive polymers are highly colored, but some, e.g., polythiophenes, are capable of being coated in thin enough layers that they are not prohibitively colored.

It has now been discovered that a cover tape having at least a partial layer of polythiophene or polyaniline conductive polymer will provide an effective static discharge capability, combined with clarity, conductivity independent of humidity and ease of use.

### SUMMARY OF THE INVENTION

The instant invention provides a pressure-sensitive adhesive cover tape for a carrier tape comprising a polyester substrate having coated on at least a portion of at least one major surface thereof:

a) a layer of an electrically conductive coating comprising a dispersion of a conductive polymer selected from the group consisting of polythiophenes and polyanilines, such polymers having conjugated polymer backbones and polymeric polyanion compounds, and a binder for the conductive polymer, and

b) a layer comprising a polymeric pressure-sensitive adhesive composition,

said tape having a degree of clarity of from about 80% to about 99%, and a surface resistance of from about 10⁴ to about 10¹² Ohm.

The instant invention further provides a carrier tape for electronic component transportations, comprising strip portions in a lengthwise direction of said tape having top and bottom surfaces, and adjacent to the strip portions, a plurality of indented segments for accommodating electronic components formed intermittently in said lengthwise direction of said tape, and a pressure-sensitive adhesive cover tape for releasably sealing said electronic component segments, said cover tape comprising a polyester substrate having coated on at least a portion of at least one major surface thereof:

a) an electrically conductive coating comprising a conductive polymer selected from the group consisting of dispersions of polythiophenes and polyanilines, such polymers having conjugated polymer backbones and polymeric polyanion compounds and a binder therefor, and

b) a polymeric pressure-sensitive adhesive composition coated on a portion of such cover tape, said portion not covering said indented segments,

said cover tape having a degree of clarity of from about 80% to about 99%, and a surface resistance of from about 10⁴ to about 10¹² Ohm.

As used herein, these terms have the following meanings.

1. The term “haze” refers to that percentage of transmitted light that deviates from the incident beam by more than 2.5° on the average.

2. The term “clarity” refers to a measurement of transmitted light which deviates from the incident beam by angles of less than 2.5°. Clarity is distance-dependent and deteriorates as the distance increases.

3. The term “conductivity” means a measure of the ability of electrical charge to move within a material.

4. “Resistivity” is the reciprocal of conductivity.

5. The term “cover tape” means a tape useful for sticking to the surface of a carrier tape, which has indented segments for accommodating and transporting chips and other sensitive electronic components.

6. The term “indented segments” refers to individual carriers, e.g., pockets or cups formed in the carrier tape to hold typically a single unit of some product. Such segments are typically formed by vacuum forming, thermoforming, molding or other known process.

7. The term “strip portion” refers to that portion of the carrier tape along each longitudinal edge, which may or may not have sprocket holes for winding.

All percentages, ratios and amounts herein are by weight unless otherwise specifically noted.

### BRIEF DESCRIPTION OF THE FIGURES

FIG. 1 is a cross-sectional view of a cover tape of the invention having a polyester backing with a conductive layer, and an adhesive layer with a polyester layer to cover such adhesive layer in the central area of the tape, so that the adhesive layer is only exposed on the parallel edges. A low-adhesion backing is adhered to the subsrate.

FIG. 2 is a cross-sectional view of a second embodiment of the invention having a polyester backing with a conductive layer, and two adhesive strips on the edges of the cover tape.

FIG. 3 is a cross-sectional view of a cover tape of the invention similar to that shown in FIG. 1, except that this embodiment also includes an extra layer of the electroconductive polymer to minimize triboelectric charges from the adhesive layer.

FIG. 4 is a cross-sectional view of a cover tape similar to that in FIG. 2 except that a low-adhesion backing is adhered to the substrate.

FIG. 5 is a fragmentary perspective view of a carrier tape with a cover tape of the invention partially in place to seal the carrier tape and partially removed to show the components stored in the indented segments. The electronic component has been omitted from the leading indented segment to show the indented segment more clearly.

### DETAILED DESCRIPTION OF THE INVENTION

Cover tapes of the invention comprise substrates having coatings of pressure-sensitive adhesives, and electrically conductive polymers.

Useful adhesive polymers are selected from pressure-sensitive adhesives such as block copolymers, natural rubbers, acrylic adhesives, silicones and the like. Silicone adhesives are not preferred because of the potential for contamination. Block copolymer adhesives include ethylene-propylene adhesives, styrene-ethylene butylenes-styrene adhesives, and the like. Such adhesives are available commercially from companies such as Shell Chemical or Exxon Chemical Company. Especially preferred are acrylate adhesives, including alkyl (meth)acrylates, and the like. The pressure-sensitive adhesive layer may further contain tackifiers, antifoaming agents, antioxidants, and the like to the extent that it does not interfere with the adhesive properties nor the clarity of the adhesives.

Preferred conductive polymers are polythiophenes and polyanilines, although others may be useful in cover tapes of the invention.

Useful polythiophenes include polythiophenes with thiophene nuclei substituted with at least one alkoxy group, or an —O(CH₂CH₂O)ₙCH₃ or thiophene nuclei that are ring closed over two oxygen atoms with an alkylene group including such group in substituted form, as described in U.S. Pat. No. 5,391,472, included herein by reference. Preferred thiophene formulas are made up of structure units:

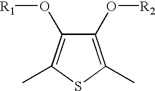

in which each of R1 and R2 independently represents hydrogen or an alkyl group having from about 1 to about 3 carbon atoms, or together represent and optionally substituted alkylene chain having from about one to about 4 carbon atoms or a cycloalkylene group, preferably an ethylene group, methylene group, substituted methylene group, an alkyl group having from about one to about 12 carbon atoms, an alkyl or phenyl substituted 1,2-ethylene group, a 1,3-propylene group or a 1,2-cyclohexylene group.

One preferred polythiophene is (poly-3,4-ethylenedioxy)thiophene complexed with polystyrene sulfonate. Suitable polymeric polyanion compounds for use in the presence of the polythiophenes are acidic polymers in free acid or salt form. Preferred acidic polymers including polymeric carboxylic or sulfonic acids. Examples include polymeric acids containing repeating units of acrylic acid, methacrylic acid, maleic acid, styrene sulfonic acid vinyl sulfonic acid and mixtures thereof. Preferred polythiophene dispersions for use in cover tapes of the invention can have a weight ratio of polythiophene polymer to polymeric polyanion(s) range from about 50/50 to about 15/85. One preferred electrically conductive polymer is a liquid dispersion of this polythiophene including a very high percentage vehicle, conductive polymer and a binder or film forming polymer. One particular embodiment contains about 10-90 weight percent of an aqueous dispersion of 1.3 weight % conductive polymer such as Baytron™ P, Baytron™ C, and the like, available from Bayer, AG, Leverkusen, Germany.

The Baytron™ P solution has been found to have very poor mechanical properties alone and must therefore be combined with a binder resin that will provide the desired mechanical properties. Latex polymer used as a binder in the polythiophene provides a good bonding between the polymeric film support and the electrically conductive layer. In addition, it must provide good abrasion resistance, optical transmission, low chemical outgassing and low extractable ionic materials. The formulation must also wet the surface of the film to be coated and evenly spread to form a uniform film over the support film.

Preferred compositions include Baytron™ P in a blend, and a highly preferred composition, available from Bayer as “CPUD2” comprises Baytron™ P (71 wt %), a polyurethane aqueous dispersion, Bayhydrol 121 (23.5 wt %), a small amount of triethylamine (0.5 wt %) and N-methyl-2-pyrrolidinone, NMP, (5 wt %). This composition, CPUD2, coated at 25 micrometers (μm) (1 mil) will produce resistance measurements of 8.8×10² to 1×10⁵ Ohm. Other resins have been found to provide good mechanical support to the electrically conductive polymers. These include resins based on copolymers of vinylidene chloride-methyl methacrylate-acrylic acid (Daran™ SL112) and copolymers of styrene-acrylic resins(Rhoplex™ P376).

Polyaniline is a conjugated polymer composed of oxidatively coupled aniline monomers, converted to a polymeric radical cationic salt with an organic acid.

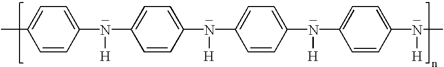

Useful polyanilines include those manufactured by Ormecon Chemie GmbH & Co., KG, Ferdinand-Harten-Str. 7, D-22949 Ammersbek. Coatings produced by the these lacquer systems on polyester film can be used to make cover tapes of the present invention. Alternatively, coated polyaniline films can be obtained from Panipol Ltd., P.O Box 163, FIN-06101, Porvoo, Finland, and tapes can be made by lamination, or by coating an adhesive directly onto the film.

Useful substrates for the adhesive tape include conventional film-forming polymers such as polyesters, (e.g., poly(ethylene terephthalate), poly(butylene terephthalate), poly(ethylene napthalate), polystyrenes, polyamides, poly(vinyl chlorides) and biaxially oriented polypropylene. Preferred substrates, also known as backings, are transparent so that they do not impair the transparency of the adhesive and conductive coatings. The substrate has a thickness of from about 5 μm (0.2 mil) to about 100 μm (4 mil), preferably from about 18 μm to about 32 μm.

In the process for producing the cover tape, the sequence of procedures may be varied as desired for the particular application.

A typical sequence of steps to form the tape may be described as follows:

First the pressure-sensitive adhesive is coated onto the substrate and dried or heat cured as required by the specific adhesive chosen. A second substrate layer is then placed over the adhesive layer in the central portion of the tape, extending longitudinally, so that only the edges of the adhesive layer are exposed. A conductive layer is coated onto the second substrate and dried, forming the cover tape. The cover tape is then wound onto a core or reel to be delivered in a roll.

In an alternate process, the conductive layer may be formed onto the polyester backing and laminated onto an adhesive tape forming the cover tape.

The cover tape is utilized by being sealed to a flexible carrier tape to protect electronic components or other parts stored therein. Typically, the uncovered carrier tape consists of indented segments which can be formed in various sizes and shapes, with parallel strip portions adjacent to each indented segment forming the longitudinal edges. This carrier type is generally provided wound around a reel as a supply roll. A component loader, whether a person or mechanical loader, will fill the indented segments with electronic components. The cover tape of the invention is likewise delivered from the roll and sealed to the carrier tape by the person or by means of a mechanical applicator to the longitudinal strip portion surfaces of the carrier tape strip portion, and the loaded carrier tape is again wound around a core or reel for storage or delivery.

Carrier tapes with cover tapes of the invention, with effective protection from contaminating conductivity provided by the electroconductive coatings are especially useful for transporting delicate electronic components including memory chips, integrated circuit chips, resistors, connectors, processors and the like. However, they can also be used outside the electronics industry to transport clips, springs, or any small part.

The following examples are meant to be illustrative and are not intended to limit the scope of the invention which is expressed solely by the claims.

### DETAILED DESCRIPTION OF THE DRAWINGS

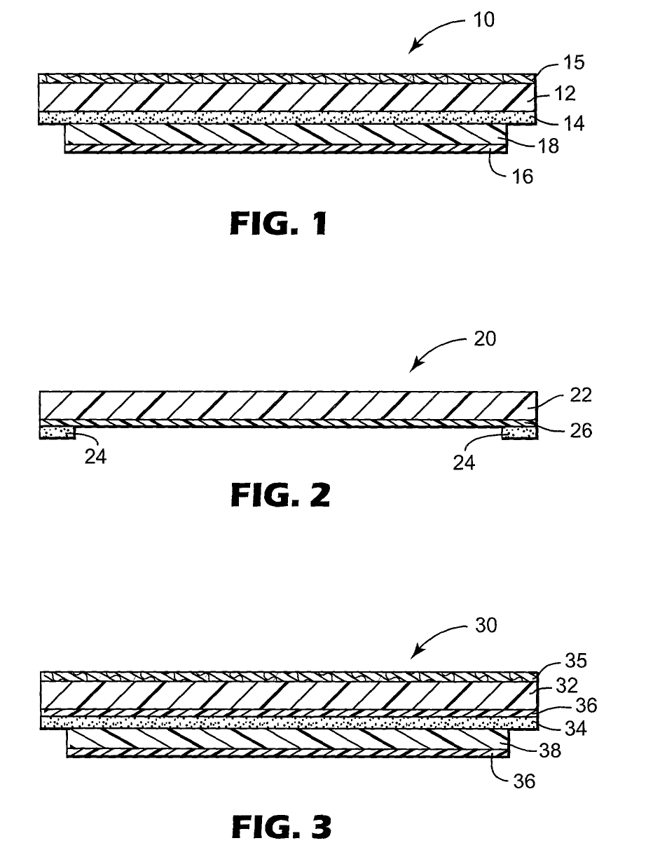

FIG. 1 shows one embodiment of a cover tape of the invention 10. The polyester substrate 12 having a thickness of about 22.75 μm (0.92 mil) has an adhesive layer 14 coated on one major surface, and a low adhesive backing 15 on the second major surface. This backing may be conductive, dissipative or non-conductive. Covering a portion of the adhesive layer 14 is a second substrate, e.g., a layer of polyester, 18 having a thickness of about 12.5 μm (0.5 mil) having a layer of electroconductive polymer 16 coated thereon. Only the portions of the pressure-sensitive adhesive layer 14 extending beyond the layer of electroconductive polymer 16 are available for adhering the cover tape to the carrier tape.

FIG. 2 is a second embodiment of a cover tape of the invention 20. A layer of electroconductive polymer 26 is coated directly onto the substrate layer 22. An adhesive layer 24 is coated down each side, making parallel stripes on the electroconductive polymer layer 26, such that the adhesive layer covers only the edge portion of the carrier tape without covering the indented segments in the carrier tape (not shown) which accommodate electronic components.

FIG. 3 shows a cover tape of the invention 30. The polyester substrate 32 having a thickness of about 22.75 μm (0.92 mil) has a layer 36 of the electroconductive material layer coated on one major surface, atop of which is an adhesive layer 34. This layer is used to provide extra protection against triboelectric charges which may result from the adhesive itself during application or removal of the cover tape. Covering a portion of the adhesive layer 34 is a second layer of polyester 38 having a thickness of about 12.5 μm (0.5 mil) having a layer of electroconductive polymer 36 coated thereon. Only the portions of the pressure-sensitive adhesive layer 34 extending beyond the layer of electroconductive polymer 36 are available for adhesion to the carrier tape. The polymer substrate has a low adhesion backing 35 on the opposing side. The backing may be conductive, dissipative or non-conductive.

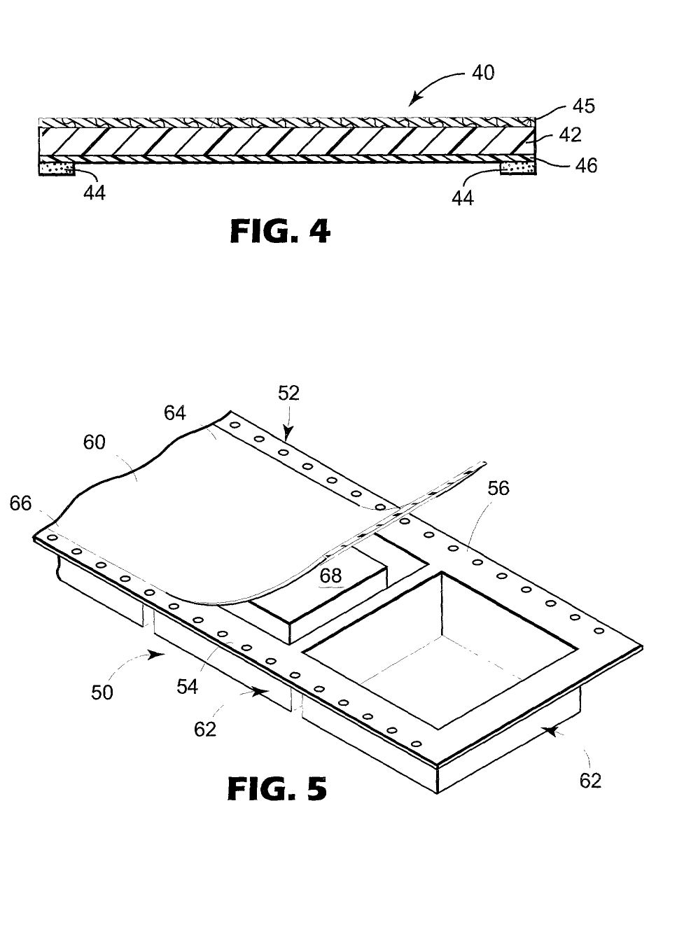

FIG. 4 shows an embodiment of a cover tape of the invention 40. The polyester substrate 42 has a low adhesive backing 45 on one side. The backing may be conductive, dissipative or non-conductive. A layer of electroconductive polymer 46 is coated directly onto the substrate layer 42. An adhesive layer 44 is coated down each side of the electroconductive polymer layer 46, such that the adhesive layer covers only the edge portion of the carrier tape without covering the indented segments in the carrier tape (not shown) which accommodate electronic components.

FIG. 5 shows a fragmentary view of a carrier tape 50 having indented segments 62 formed intermittently in a lengthwise direction of the carrier tape with adjacent strip portion 52 having edge portions 54 and 56. Cover tape 60 is applied over the indented segments 62 of the carrier tape and sealed to retain the components 68 therein and protect the components from dirt and other contaminants. The cover tape 60 is releasably sealed to the top surface of strip portion 52 so that it can be subsequently removed to access the stored components. In this embodiment the cover tape 60 includes adhesively bonded areas 64 and 66 that are bonded to longitudinal edge surfaces 54 and 56 of the strip portion 52. The indented segments 62 shown have four sidewalls, however, infinite variations of shape and size are possible for these segments, depending on the type, size and shape of component 68 to be stored.

### Test Methods

### Resistance Test

This test method used requires the ProStat™ PRS-801 resistance system and a PRF-914 High Resistance Concentric Ring Fixture, both available from Prostat Corporation, 1072 Tower Lane, Bensenville, Ill. 60106. A nonconductive board, and a calibration shunt are also required.

The outer three wraps of the roll of material to be tested were removed. Samples were 6 mm wide. The samples were conditioned in the room for 24 hours. The PRS 801 was warmed up for 3 minutes, and the calibration shunt was then inserted across the test terminals, and “RESET” was pressed followed by “CLEAR” within ½ second. The word “CAL” appeared in LCD display. Once “CAL” was displayed, RESET was pressed to calibrate the PRS 801 to the calibration shunt. This set the unit to 1.02 Ohm. Then to confirm the calibration, TEST was pressed while the calibration shunt was still in place. The shunt measures 1.02+/−0.02 Ohm. (If it's not within +/−0.02 Ohm, repeat the process.)

The specimen to be tested was placed on a non-conductive surface. Useful surfaces include a rubber mat or a cutting board. The rubber conductive shoes were installed on the bottom of micro-probe, and the micro-probe was connected to the meter. The power was then turned on and “MODE” pressed to set form to exponential. The micro-probe was placed on top of the sample, making sure it was perpendicular to the surface. The micro-probe was then pressed firmly to collapse the centerpiece of the probe and to insure firm contact between the outer ring of the micro-probe and the surface of the specimen. The “TEST” button was then pressed. Once the display stopped changing and the word “HOLD” appeared, the digital output from the main display was recorded, including the exponent. (The display is in the form of a real number followed by an “E,” followed by an integer. The “E” is an abbreviation for exponent and the integer is the exponent value. For instance, “1.2E04” would be 1.2×10⁴ Ohm.) The probe was removed from the sample, and the “RESET” button pressed prior to repetition of the procedure. Resistance was reported using three significant digits and an exponent.

### Optical Tests

The optical tests involved measurement of haze, clarity and transmission using a BYK-Gardner, Haze-Gard Plus™ No. 4725 (BYK-Gardner USA, Rivers Park II, 9104 Guilford Road, Columbia, Md. 21046 USA). The Haze-Gard Plus™, from BYK Gardner, was used to take the optical measurements of haze, clarity, and total transmittance. The instrument was allowed to warm up for two minutes prior to use. The desired parameter was selected by pressing a button on the unit marked either “transmittance,” “haze,” or “clarity.” The coated film sample, or coated film laminated to adhesive-coated film, was placed into the appropriate port (haze port on right side for transmittance and haze, and clarity port on the left side for clarity). The given measurement was obtained by pressing the “operate” button on the unit. Measurement range is from 0 to 100% for all three optical measurements. The manufacturer states measurement repeatability of +/−0.1 units, and reproducibility of +/−0.4 units.

Total transmittance was measured according to BYK Gardner, as the ratio of total transmitted light to incident light, reduced by reflectance and absorbance. According to ASTM D 1003, haze was measured as the percentage of transmitted light that deviated from the incident beam by more than 2.5° on the average. (Simply speaking, haze is a measure of the cloudiness of the material being measured.) Clarity, on the other hand, can be evaluated at angles of less than 2.5°. Clarity can be likened to the crispness or definition of an image as viewed through the substrate.

### Gravure Coating

Gravure roll coating is often used when a very thin coating is needed and/or when low viscosity solutions are coated. Gravure coated film generally produces the best optical properties. A gravure roll is typically a steel roll with lines machined into the surface of varying depth, width, number and angle. This roll is typically flooded with the coating solution and the excess is removed with a doctor blade to produce a uniform quantity of the solution in the surface groves of the roll. The roll is rotated against the passing film to be coated in either a forward or backward motion to deliver the solution. The coated film immediately passes through an oven where the solvents are removed leaving the dried coating on the film.

### EXAMPLES

### Coating Examples 1-18

The conductive polymer solution, CPUD-2, comprising Baytron™ P (71 wt %), Bayhydrol 121 (23.5 wt %), Triethylamine (0.5 wt %) N-methyl-pyrrolidinone (NMP) (5 wt %), Bayer Industrial Chemicals Division, 100 Bayer Road, Pittsburgh, Pa. 15205-9741), and an optional wetting agent Triton™ X100 (Aldrich, 1001 West Saint Paul Avenue, Milwaukee, Wis. 53233), was diluted with methanol and/or water at the various concentrations noted in Table 1. These solutions were then coated onto a 12.5 μm (0.5 mil) polyester film. The polyester film in some cases was left untreated, and in others was either corona treated or coated with a polyvinyldiene chloride (PVdC) layer, Terphane™ 22.00, available from Terphane, Inc., 2754 West Park Drive, Bloomfield, N.Y. 14469. The examples are noted in the table as untreated or the treatment is identified. In coating examples 1-18, a 200P or 200RM 120P or 150P Gravure roller was used, as indicated.

Film samples were prepared using a conventional forward gravure coater with a priming station and two sets of dryers: primer dryer and convection dryer. The solutions that were coated ranged from 1.6 to 2.0 percent solids. A gravure roll with 120 lines per inch, pyramidal patterned, was driven in a forward direction, delivering between 0.37 and 0.57 g/ft of wet solution onto the film at a coating speed of 20 fpm. The film was then dried by passing through a 5 foot long priming oven heated at 200° F. and then through a 10 foot long convection oven at 150° F. These coatings were then tested for surface resistance, clarity, haze and transmittance.

### Coating Examples 19-39

The conductive polymer Baytron™ P was combined with the binder resin Rhoplex™ P-376 (Rohm & Haas, 100 Independence Mall West, Philadelphia, Pa. 19106) or Daran™ SL112 (W. R. Grace & Co. Darex Container Products, 62 Whittemore Ave., Cambridge, Mass., 02140), in water. The solution was then coated by Gravure method using a 150P, 120P, or 130QCH gravure roller, as indicated in Table 2.

### Tape Examples 40-44

Tape Examples 40 and 41 were created from coating Examples 4, and 5 were laminated to the 2656 Pressure-sensitive cover tape (3M, Electronic Handling & Protection Division, 6801 Riverplace Blvd., Austin, Tex. 78726-9000). Tape Example 42 was created from Coating Example 6, laminated to a tape formed from a synthetic rubber based pressure-sensitive adhesive on a polyester backing, to make the final cover tape. Lamination was done by adhering the conductive film onto the pressure-sensitive adhesive tape and pressing them between two nip rollers with sufficient pressure to form a bubble-free lamination, about 20-40 psi pressure. The resultant tape was then tested for light transmission, haze, clarity, and conductivity properties.

For Tape Example 44, Panipol™ OMO62, a polyaniline spray coating on polyester made by Panipol Ltd. (Panipol Ltd., PO Box 163, FIN-06101, Porvoo, Finland) was adhered to the 2656 pressure-sensitive cover tape (3M, Electronic Handling & Protection Division, 6801 Riverplace Blvd., Austin, Tex. 78726-9000) and tested for surface resistance, clarity, and transmission.

For Tape Example 45, Panipol™ FB 0936, a polyaniline coating on a blown polyurethane file, available from the aforementioned company, was adhered the 2656 Pressure-sensitive cover tape (3M, Electronic Handling & Protection Division, 6801 Riverplace Blvd., Austin, Tex. 78726-9000) and tested. Results for all these Examples are found in Table 3.

Comparative Tape Examples 45C thru 50C

Commercially available cover tapes were tested to compare properties to the improved properties of tapes of the invention. Tape Example 45C employed the 3M non-conductive 2656 pressure-sensitive adhesive cover tape. Tape Example 46C was formed from the 3M conductive 2666 PSA cover tape (3M, Electronic Handling & Protection Division, 6801 Riverplace Blvd., Austin, Tex. 78726-9000). Tape Example 47C used a tape formed from a synthetic rubber based pressure-sensitive adhesive on a polyester backing, with a non-conductive poly(ethyelene terephthalate) (PET) film. Lamination was done by adhering the PET film onto the pressure-sensitive tape and pressing them between two nip rollers with sufficient pressure to get a bubble-free lamination. Tape Example 48C used the Advantek™ AA static dissipative heat-activated cover tape, (Advantek, Inc., 501 Clearwater Drive, Minnetonka, Minn. 55343). Tape Example 49C used Advantek's PS cover tape, lot# PSA21305AD, and Tape Example 50C was Advantek Type PS cover tape, lot #PS013305AD. Results for these Comparative Examples are found in Table 3.

TABLE 1
Coating Examples

| | | Conducting | | | | | | | Trans- |
|---|---|---|---|---|---|---|---|---|---|
| | | Polymer | | | Coating | Surface Resistance | Clarity | Haze | mission |
| Sample # | Substrate | Solution | Wetting Agent | Solvent(s) | Method | (Ohms) | % | % | % |
| 1 | Polyester | CPUD2, 10% | | Methanol, 90% | 200P | 2.1E10 @ 50% RH | 99.1 | 3.0 | 89.7 |
| 2 | Polyester | CPUD2, 10% | | Methanol, 90% | 200RM | 1.3E6 @ 50% RH | 99.1 | 2.6 | 89.9 |
| 3 | Polyester | CPUD2, 15% | | Methanol, 85% | 200RM | 5.0E5 @ 50% RH | 99.2 | 2.4 | 91.1 |
| 4 | Polyester | CPUD2, 25% | | Methanol, 75% | 200RM | 2.4E5 @ 50% RH | 99.1 | 2.5 | 90.7 |
| 5 | Polyester | CPUD2, 35% | | Methanol, 65% | 200RM | 6.5E4 @ 50% RH | 99.2 | 2.2 | 88.7 |
| 6 | Polyester | CPUD2, 7% | Triton X100, 0.1% | DI Water, 82.9% | 200RM | 1.8E8 | 98.8 | 4.5 | 90.6 |
| 7 | Corona treated PET | CPUD2, 10% | Triton X100, 0.1% | DI Water, 89.9% | 200RM | 5.8E5 | 98.9 | 5.0 | 90.8 |
| 8 | Corona treated PET | CPUD2, 6% | Triton X100, 0.1% | DI Water, 89.9% | 200RM | 8.9E9 | 99.1 | 2.7 | 89.9 |
| 9 | Corona treated PET | CPUD2, 6% | Triton X100, 0.1% | DI Water, 89.9% | 200RM | 4.3E9 | 99.1 | 2.5 | 90.0 |
| 10 | Corona treated PET | CPUD2, 7% | Triton X100, 0.2% | DI Water, 89.9% | 200RM | 5.2E8 | 99.1 | 2.6 | 89.9 |
| 11 | Corona treated PET | CPUD2, 7% | Triton X100, 0.2% | DI Water, 89.9% | 200RM | 7.5E8 | 99.1 | 2.9 | 89.8 |
| 12 | Corona treated PET | CPUD2, 7% | | DI Water, 83.7% | 200RM | 6.2E12 | 98.7 | 3.1 | 89.8 |
| | | | | Methanol, 9.3% | | | | | |
| 13 | Terphane 22.00 | CPUD2, 10% | | DI Water, 90% | 120P | 5.6E08 | 93.7 | 7.91 | 90.5 |
| 14 | Terphane 22.00 | CPUD2, 14% | | DI Water, 86% | 120P | 5.5E06 | 94.2 | 4.86 | 90.1 |
| 15 | Terphane 22.00 | CPUD2, 6% | | DI Water, 94% | 120P | 3.5E12 | 94.4 | 4.78 | 90.1 |
| 16 | Terphane 22.00 | CPUD2, 6% | | DI Water, 94% | 150P | 5.9E08 | 93.1 | 5.65 | 89.8 |
| 17 | Terphane 22.00 | CPUD2, 14% | | DI Water, 86% | 150P | 4.9E05 | 93.1 | 4.45 | 90.3 |
| 18 | Terphane 22.00 | CPUD2, 10% | | DI Water, 90% | 150P | 1.8E06 | 94.2 | 4.65 | 89.7 |

TABLE 2
Conductive Films

| Sample | | Conducting | | | Coating | Surface Resistance | Clarity | Haze | Transmission |
|---|---|---|---|---|---|---|---|---|---|
| # | Substrate | Polymer | Binder | DI Water | Method | (Ohms) | % | % | % |
| 19 | Terphane 22.00 | Baytron P, 10% | Rhoplex P376, 3% | 87% | 150P | 2.2E08 | 93.9 | 6.87 | 91.4 |
| 20 | Terphane 22.00 | Baytron P, 3% | Rhoplex P376, 12% | 85% | 150P | 7.1E12 | 93.8 | 5.19 | 91.6 |
| 21 | Terphane 22.00 | Baytron P, 6.5% | Rhoplex P376, 7.5% | 86% | 150P | 1.4E10 | 93.7 | 5.35 | 90.8 |
| 22 | Terphane 22.00 | Baytron P, 6.5% | Daran SL112, 7.5% | 86% | 150P | 2.9E09 | 93.6 | 6.09 | 90.1 |
| 23 | Terphane 22.00 | Baytron P, 10% | Daran SL112, 12% | 78% | 150P | 1.5E08 | 93.3 | 7.05 | 90.1 |
| 24 | Terphane 22.00 | Baytron P, 3% | Daran SL112, 3% | 94% | 150P | 1.0E13 | 92.9 | 6.64 | 91.2 |
| 25 | Terphane 22.00 | Baytron P, 10% | Daran SL112, 12% | 78% | 120P | 1.7E09 | 93.1 | 6.58 | 88.7 |
| 26 | 0.56 mil PET, | Baytron P, 10% | Daran SL112, 12% | 78% | 120P | 7.4E08 | 99.0 | 4.30 | 89.8 |
| | corona treated | | | | | | | | |
| 27 | Terphane 22.00 | Baytron P, 3% | Daran SL112, 3% | 94% | 120P | 7.6E12 | 93.9 | 7.16 | 89.7 |
| 28 | Terphane 22.00 | Baytron P, 6.5% | Daran SL112, 7.5 | 86% | 120P | 5.4E12 | 93.5 | 5.74 | 89.6 |
| 29 | Terphane 22.00 | Baytron P, 3% | Rhoplex P376, 12% | 85% | 120P | 7.9E12 | 93.1 | 4.98 | 91.1 |
| 30 | Terphane 22.00 | Baytron P, 6.5% | Rhoplex P376, 7.5% | 86% | 120P | 3.2E12 | 93.5 | 5.65 | 90.8 |
| 31 | 0.56 mil PET, | Baytron P, 6.5% | Rhoplex P376, 7.5% | 86% | 120P | 2.3E12 | 99.1 | 3.10 | 90.1 |
| | corona treated | | | | | | | | |
| 32 | Terphane 22.00 | Baytron P, 10% | Rhoplex P376, 3% | 87% | 120P | 2.5E09 | 93.9 | 6.63 | 91.3 |
| 33 | 0.56 mil PET, | Baytron P, 10% | Rhoplex P376, 3% | 87% | 120P | 5.4E08 | 99.1 | 3.41 | 90.6 |
| | corona treated | | | | | | | | |
| 34 | Terphane 22.00 | Baytron P, 10% | Rhoplex, 3% | 87% | 130QCH | 6.8E09 | 94.2 | 4.96 | 90.9 |
| 35 | Terphane 22.00 | Baytron P, 6.5% | Rhoplex, 7.5% | 86% | 130QCH | 1.2E13 | 93.2 | 5.94 | 90.9 |
| 36 | Terphane 22.00 | Baytron P, 10% | Daran, 12% | 78% | 130QCH | 1.7E + 9 | 93.0 | 6.30 | 90.7 |
| 37 | Terphane 22.00 | Baytron P, 6.5% | Daran, 7.5% | 86% | 130QCH | 1.1E13 | 93.3 | 6.07 | 90.5 |
| 38 | Terphane 22.00 | Baytron P, 10% | Rhoplex, 3% | 87% | 130QCH | 1.8E10 | 93.8 | 6.97 | 89.1 |
| 39 | Terphane 22.00 | Baytron P, 10% | Daran, 12% | 78% | 130QCH | 6.3E09 | 93.7 | 6.42 | 90.8 |

TABLE 3
Cover Tapes

| | | | | Surface | | | |
|---|---|---|---|---|---|---|---|
| | | | | Resistance @ | | | Trans- |
| Sample | | Conducting | Lamination | 50% RH | Clarity | Haze | mission |
| # | Substrate | Film | Method | (Ohm) | % | % | % |
| 40 | 2656 PSA tape | Sample 4 | Nip rollers | 2.0E5 | 97.5 | 8.3 | 88.3 |
| | with blocker | | | | | | |
| | RV-37 | | | | | | |
| 41 | 2656 PSA tape | Sample 5 | Nip rollers | 5.3E4 | 97.7 | 6.1 | 89.4 |
| | with blocker | | | | | | |
| | RV-37 | | | | | | |
| 42 | Rubber based | Sample 6 | Nip rollers | 1.8E8 | 96.7 | 10.9 | 88.3 |
| | Adhesive tape | | | | | | |
| 43 | 2656 PSA tape | Polyaniline | Roller | 8.3E4 | 92.8 | 7.3 | 79.7 |
| | w/conductive | coated | | | | | |
| | blocker | polyester film | | | | | |
| 44 | 2656 PSA tape | Blown | Roller | 2.9E04 | 55.6 | 23.9 | 38.6 |
| | w/conductive | polyethylene/ | | | | | |
| | blocker | polyaniline film | | | | | |
| 45C | 2656 PSA tape | non-conductive | Nip rollers | 1.3E13 | 97.8 | 6.4 | 89.1 |
| | w/clear PET | PET film | | | | | |
| | blocker | | | | | | |
| 46C | 2666 PSA tape | metal | Nip rollers | 5.2E5 | 91.7 | 5.4 | 80.4 |
| | w/conductive | | | | | | |
| | PET blocker | | | | | | |
| 47C | Rubber Based | Non-conductive | Nip rollers | 1.3E13 | 97.0 | 8.1 | 88.2 |
| | Adhesive tape | PET film | | | | | |
| 48C | Advantek AA | Ionic salt | unknown | 3.0E10 | 19.2 | 61.9 | 90.5 |
| | tape | | | | | | |
| 49C | Advantek PS | Unknown | unknown | 4.6E7 | 32.8 | 45.0 | 84.8 |
| | Tape | | | | | | |
| 50C | Advantek PS | unknown | unknown | 8.1E7 | 45.3 | 27.3 | 91.7 |
| | Tape | | | | | | |

What is claimed is:

1. A pressure-sensitive adhesive cover tape comprising a polyester substrate having coated on at least a portion of at least one major surface thereof:
a) a layer of an electrically conductive coating comprising a dispersion of a conductive polymer selected from the group consisting of polythiophenes and polyanilines, said polymer having a conjugated polymer backbone, said dispersion containing at least one polymeric polyanion compounds, and at least one binder, and
b) a layer comprising a polymeric pressure-sensitive adhesive composition,
said tape having a degree of clarity of from about 80% to about 99%, and a surface resistance of from about 1×10⁴ to about 1×10¹² Ohm.

2. A pressure-sensitive adhesive cover tape according to claim 1 wherein said tape further includes a low-adhesion backing releasably adhered to said polyester substrate.

3. A pressure-sensitive adhesive cover tape according to claim 1 wherein said clarity is from 90% to about 99%.

4. A pressure-sensitive adhesive cover tape according to claim 1 wherein said polythiophene dispersion comprises (poly-3,4-ethylenedioxy)thiophene.

5. A pressure-sensitive adhesive cover tape according to claim 1 wherein said polymeric polyanion compound comprises at least one acidic polymer, said polymer being in a form selected from a free acid or a salt form.

6. A pressure-sensitive adhesive cover tape according to claim 1 wherein said binder is selected from the group consisting of copolyesters containing sulfonic acid groups.

7. A carrier tape for electronic component transportation, comprising parallel strip portions in a lengthwise direction of said tape, said strip portions having top and bottom surfaces, and between said parallel strip portions, a plurality of indented segments for accommodating electronic components formed intermittently in said lengthwise direction of said tape, and a pressure-sensitive adhesive cover tape for releasably sealing said indented segments, said cover tape having parallel bonding portions being adhesively bonded to said top surface of said parallel strip portions, said cover tape comprising a polyester substrate having coated on at least one portion of at least one major surface thereof,
a) an electrically conductive coating comprising a dispersion of a conductive polymer selected from the group consisting of polythiophenes and polyanilines, said polymer having a conjugated polymer backbone, at least one polymeric polyanion compound, and at least one binder, and
b) a polymeric pressure-sensitive adhesive composition coated on at least one bonding portion of said cover tape,
said cover tape having a degree of clarity of from about 80% to about 99%, and a surface resistance of from about 1×10⁴ to about 1×10¹² Ohm.

8. A carrier tape according to claim 7 wherein said cover tape further indicates a low-adhesion backing releasably adhered to said polyester substrate.

9. A carrier tape according to claim 7 wherein said clarity is from 90% to about 99%.

10. A carrier tape according to claim 7 wherein said polythiophene dispersion comprises (poly-3,4-ethylenedioxy)thiophene.

11. A carrier tape according to claim 7 wherein said polymeric polyanion compound comprises at least one acidic polymer, said polymer being in a form selected from a free acid or a salt form.

12. A carrier tape according to claim 7 wherein said binder is selected from the group consisting of copolyesters containing sulfonic acid groups.

13. A carrier tape according to claim 7 wherein said pressure-sensitive adhesive composition is coated onto said substrate as a single continuous layer having an attachment surface and an opposing surface, wherein at least a portion of said opposing surface is covered by a second substrate, said second substrate having said layer of said electroconductive coating coated thereon.

14. A carrier tape according to claim 13 having an additional layer of said electroconductive coating atop said polyester substrate.

15. A carrier tape according to claim 7 wherein said substrate has a layer of said electroconductive coating coated thereon and atop said electroconductive coating, parallel stripes of said pressure-sensitive adhesive composition being coated on said parallel bonding portions of said cover tape.
